(19) United States
(12) Patent Application Publication
(10) Pub. No.: US 2021/0147052 A1
(43) Pub. Date: May 20, 2021

(54) VEHICULAR SYSTEM

(71) Applicant: DEEP TREKKER INC, Kitchener (CA)

(72) Inventor: Jeffrey Paul Lotz, KITCHENER (CA)

(21) Appl. No.: 16/688,066

(22) Filed: Nov. 19, 2019

(51) Int. Cl. B63H 5/125; B63G 8/08; B63G 8/16; G05D 1/10; G05D 1/04; B63G 8/00

(52) U.S. Cl. CPC B63H 5/125; B63G 8/08; B63G 8/16; B63G 2008/005; G05D 1/048; B63G 8/001; G05D 1/10

(57) ABSTRACT

Disclosed herein is a vehicular system, in accordance with some embodiments. Accordingly, the vehicular system may include a body, a rotatable head, a plurality of devices, a propulsion assembly, at least one actuator, a power source, and a controller. Further, the rotatable head rotatably coupled to the body. Further, the plurality of devices mounted on the rotatable head. Further, the plurality of devices may include a grabber device and at least one sensing device. Further, the propulsion assembly coupled to the body. Further, the propulsion assembly may be electrically powered. Further, the at least one actuator operationally coupled to the rotatable head. Further, the at least one actuator may be configured to perform at least one actuator operation. Further, the power source electrically coupled to the at least one actuator and a propulsion assembly. Further, the controller communicatively coupled to the at least one actuator.

### FIELD OF THE INVENTION

Generally, the present disclosure relates to the field of vehicles. More specifically, the present disclosure relates to a vehicular system.

### BACKGROUND

A vehicular system may include a remotely operated vehicle (ROV). The remotely operated vehicle (ROV) is an unoccupied, highly maneuverable underwater robot that is connected to an operator device through a tether. Further, the tether may include cables. Further, the ROV is used for military operations, commercial operations, and scientific inspections, etc. conducted in deep water. Further, the ROV is operated by an operator on the surface using the operator device. Further, the cables communicate data and control signals between the operator device and the ROV.

Existing ROVs are deficient with regard to several aspects. For instance, the ROVs have low operational speed. Further, the ROVs do not have precise navigational control. Furthermore, the ROVs have a fixed camera that restricts the field of view. Moreover, the ROVs have a fixed SONAR device that restrict the navigational ability of the ROVs.

Therefore, there is a need for an improved vehicular system, that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a vehicular system, in accordance with some embodiments. Accordingly, the vehicular system may include a body, a rotatable head, a plurality of devices, a propulsion assembly, at least one actuator, a power source, and a controller. Further, the rotatable head rotatably coupled to the body. Further, the rotatable head may be configured to rotate through a plurality of positions in relation to the body. Further, the plurality of devices mounted on the rotatable head. Further, the plurality of devices may include a grabber device and at least one sensing device. Further, the grabber device may be configured to perform at least one grabbing operation. Further, the at least one sensing device may be configured to perform at least one sensing operation. Further, the propulsion assembly coupled to the body. Further, the propulsion assembly may be electrically powered. Further, the propulsion assembly may be configured to propel the vehicular system. Further, the at least one actuator operationally coupled to the rotatable head. Further, the at least one actuator may be configured to perform at least one actuator operation. Further, the at least one actuator operation may include rotating the rotatable head through a plurality of positions in relation to the body. Further, the power source electrically coupled to the at least one actuator and a propulsion assembly. Further, the power source may be configured to supply electrical power to the at least one actuator and the propulsion assembly. Further, the controller communicatively coupled to the at least one actuator. Further, the controller may be configured to control the at least one actuator operation of the at least one actuator.

Further, disclosed herein is a vehicular system, in accordance with some embodiments. Accordingly, the vehicular system may include a body, a rotatable head, a plurality of devices, a propulsion assembly, at least one actuator, a power source, and a controller. Further, the rotatable head rotatably coupled to the body. Further, the rotatable head may be configured to rotate through a plurality of positions in relation to the body. Further, the plurality of devices movably mounted on the rotatable head. Further, the plurality of devices may include a grabber device and at least one sensing device. Further, the grabber device may be configured to perform at least one grabbing operation. Further, the at least one sensing device may be configured to perform at least one sensing operation. Further, the propulsion assembly coupled to the body. Further, the propulsion assembly may include a plurality of thrusters. Further, the plurality of thrusters may be electrically powered. Further, the plurality of thrusters may be configured to propel the vehicular system in a plurality of directions. Further, the at least one actuator operationally coupled to the rotatable head. Further, the at least one actuator may be configured to perform at least one actuator operation. Further, the at least one actuator operation may include rotating the rotatable head through a plurality of positions in relation to the body. Further, the power source electrically coupled to the at least one actuator and a propulsion assembly. Further, the power source may be configured to supply electrical power to the at least one actuator and the propulsion assembly. Further, the controller communicatively coupled to the at least one actuator. Further, the controller may be configured to control the at least one actuator operation of the at least one actuator.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a perspective view of a vehicular system, in accordance with some embodiments.

FIG. 3 is a side view of the vehicular system, in accordance with some embodiments.

FIG. 4 is a bottom view of the vehicular system, in accordance with some embodiments.

FIG. 5 is a top view of the vehicular system, in accordance with some embodiments.

FIG. 6 is a front view of the vehicular system, in accordance with some embodiments.

FIG. 7 is an enlarged cross-sectional view of region C in FIG. 5, in accordance with some embodiments.

FIG. 8 is a perspective view of a vehicular system, in accordance with some embodiments.

FIG. 9 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of the best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a vehicular system, embodiments of the present disclosure are not limited to use only in this context.

Overview:

The present disclosure describes a vehicular system. Further, the vehicular system may include a remotely operated vehicle (ROV). Further, the ROV may solve the most challenging operating conditions encountered in the deep water and thus delivers reliability, stability and intuitive controls. Further, the ROV may include improved software intelligence enhancing operator's experience with easy controls, auto-stabilization, wireless connectivity, and augmented recording capabilities. Further, the ROV may provide enhanced viewing experience which may include viewing a live 4K Ultra HD video that may be recorded directly to the waterproof hand-held 7-inch controller. Further, the 7-inch controller is sunlight-readable and may have an HD screen allowing the clearest view of underwater inspections. Further, the 7-inch controller may have improved interface allowing for simultaneous viewing of sonar data and live video without bulky, externally-powered control consoles. Further, the ROV may be coupled with the driving force of ‘BRIDGE™’. Further, the driving force of ‘BRIDGE™’ may provide advanced control and stability to the ROV. Further, the ROV may be equipped with an automated station holding, a camera, a sonar, and a manipulator capable of 260° rotations. Further, the ROV may go up to 305 m (1000 ft) of depth in the ocean. Further, the ROV may be a portable solution with internal batteries and integrated equipment. Further, the internal batteries may be interchangeable and may last up to 8 hours. Further, the ROV may be deployable within 1-minute that proves to be an ideal tool for mission-ready situations.

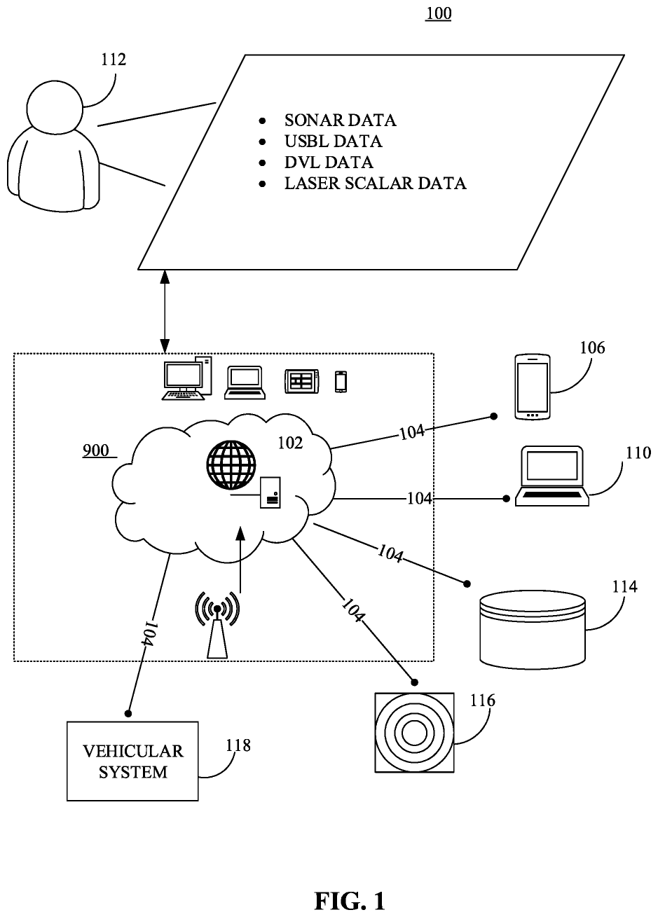

FIG. 1 is an illustration of an online platform 100 consistent with various embodiments of the present disclosure. By way of non-limiting example, the online platform 100 to a may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 900.

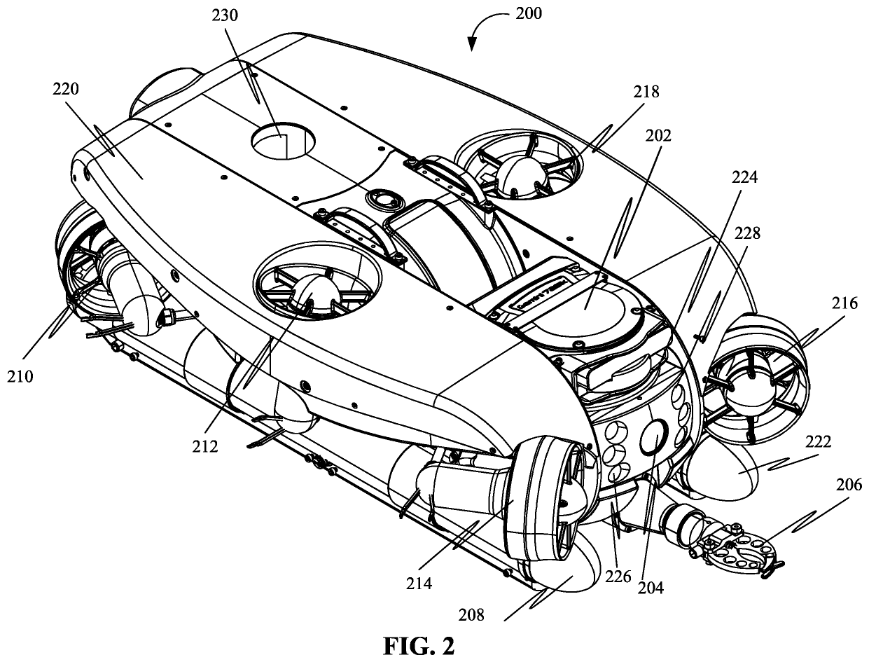

FIG. 2 is a perspective view of a vehicular system 200, in accordance with some embodiments. Further, the vehicular system 200 may include a body 220, a rotatable head 202, a plurality of devices, a propulsion assembly, at least one actuator, a power source, a controller.

Further, in an instance, the vehicular system 200 may be associated with three dimensions. Further, in an instance, the three dimensions may include width, height, and length of 440 mm (17.3″), 235 mm (9.3″), and 717 mm (28.2″) respectively. Further, the vehicular system 200 may be associated with a bodyweight. Further, in an instance, the bodyweight may be 26 kg (57 lbs). Further, the vehicular system 200 may include a window material. Further, the window material may include a sapphire material and an acrylic material. Further, in an instance, the vehicular system 200 may be associated with a depth rating of 305 m (1000 ft) in water. Further, the vehicular system 200 may be associated with an operating temperature. Further, in an instance, the operating temperature may vary from −10° C. to 50° C. (14° F. to 122° F.). Further, the vehicular system 200 may be associated with a case. Further, in an instance, the case may be of Custom Pelican™ Air 1650 with handle and wheels. Further, the vehicular system 200 may be associated with a tether. Further, in an instance, the tether may include tether diameter and tether length of 4.5 mm (0.18″) and 800 m respectively. Further, the tether may include tether weight which may be neutrally buoyant in water. Further, the tether may include tether breaking strength of 90 kg (2001b).

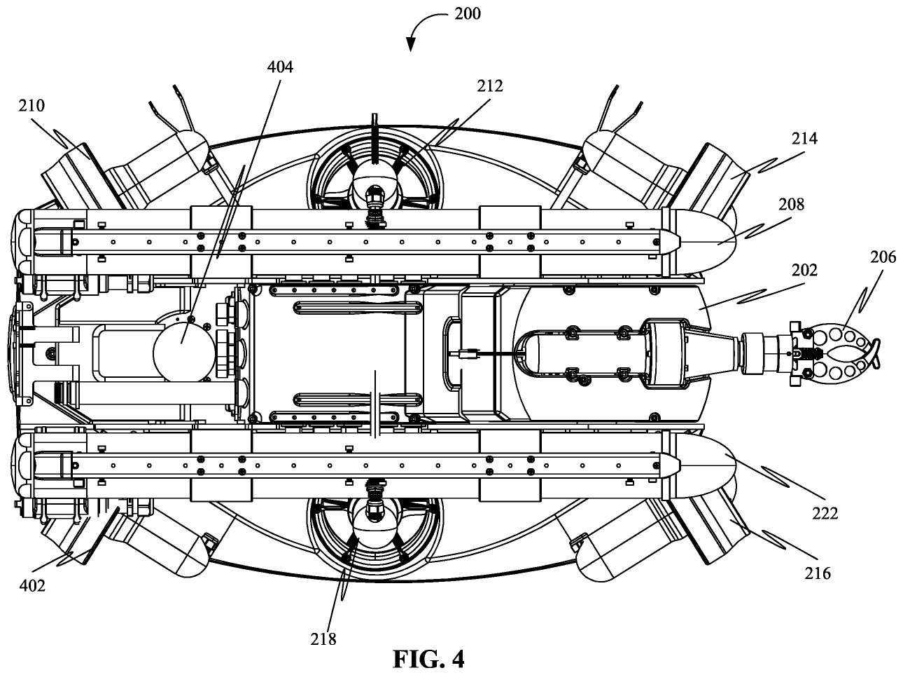

Further, the body 220 may include the rotatable head 202, the plurality of devices, and the propulsion assembly. In some embodiments, the propulsion assembly may include a plurality of thrusters 210, 212, 214, 216, 218, and 402 as shown in FIG. 4. Further, the body 220, in an instance, may be associated with a body material. Further, the body material may include anodized machined aluminum material, carbon fiber material, stainless steel material, and buoyancy foam material. Further, the body 220, in an instance, may include at least one navigational device. Further, the at least one navigational device may include Doppler Velocity Log device (DVL) 404, as shown in FIG. 4, and Ultra-short baseline device (USBL) 230.

Further, the rotatable head 202 rotatably coupled to the body 220. Further, the rotatable head may be configured to rotate through a plurality of positions in relation to the body 220. Further, the plurality of devices may be mounted on the rotatable head 202. Further, the plurality of devices may include a grabber device 206 and at least one sensing device. Further, the grabber device 206 may be configured to perform at least one grabbing operation. Further, the grabber device 206 may include two grabber arms. Further, the two grabber arms may include a gripper material attached to the edge of the two grabber arms. Further, the gripper material may include a rubber, a neoprene, etc. Further, the at least one sensing device may be configured to perform at least one sensing operation. Further, the at least one sensing device may include a Sound Navigation and Ranging (SONAR) device 224, an Ultra-Short Baseline (USBL) device 230, a Doppler Velocity Log (DVL) device 404, and a laser scaler device 226. Further, the SONAR device 224 may help in determining an obstruction beyond the visibility of the vehicular system 200. Further, the SONAR device 224 may be configured to generate SONAR data. Further, SONAR data may be transmitted to the online platform 100. Further, the online platform 100 may be configured to receive the SONAR data. Further, the SONAR data may be transmitted to a user device. Further, the user device may be configured to receive the SONAR data. Further, the user device may include a controller. Further, in an instance, the controller may be a waterproof hand-held controller with 78 mm (7-inch) 16:9 wide-angle LCD screen. Further, in an instance, the controller may include connectivity options such as, but not limited to, USB, SD, HDMI, Ethernet, etc. Further, the USBL device 230 may determine underwater acoustic positioning of the vehicular system 200. Further, the USBL device 230 may be configured to generate USBL data. Further, the USBL data may be transmitted to the online platform 100. Further, the online platform 100 may be configured to receive the USBL data. Further, the at USBL data may be transmitted to the user device. Further, the user device may be configured to receive the USBL data. Further, the DVL device 404 may determine velocity of the vehicular system 200 relative to the bottom of the ocean. Further, the DVL device 404 may be configured to generate DVL data. Further, the DVL data may be transmitted to the online platform 100. Further, the online platform 100 may be configured to receive the DVL data. Further, the DVL data may be transmitted to the user device. Further, the user device may be configured to receive the DVL data. Further, the laser scaler device 226 may determine size of an object in front of the vehicular system 200. Further, the object may include a fish, a whale, etc. Further, the laser scaler device 226 may be configured to generate laser scaler data. Further, the laser scaler data may be transmitted to the online platform 100. Further, the online platform 100 may be configured to receive the laser scaler data. Further, the laser scaler data may be transmitted to the user device. Further, the user device may be configured to receive the laser scaler data. Further, the rotatable head may include at least one LED light 228. Further, the at least one LED light 228 may be used for illumination purposes.

Further, the propulsion assembly coupled to the body 220. Further, the propulsion assembly may be electrically powered. Further, the propulsion assembly may be configured to propel the vehicular system 200.

Further, the at least one actuator may be operationally coupled to the rotatable head 202. Further, the at least one actuator may be configured to perform at least one actuator operation. Further, the at least one actuator may include a hydraulic actuator, a pneumatic actuator, an electrical actuator, etc. Further, the at least one actuator operation may include rotating the rotatable head 202 through a plurality of positions in relation to the body 220.

Further, the power source electrically coupled to the at least one actuator and a propulsion assembly. Further, the power source may be configured to supply electrical power to the at least one actuator and the propulsion assembly.

Further, the controller communicatively coupled to the at least one actuator. Further, the controller may be configured to control the at least one actuator operation of the at least one actuator.

Further, in an embodiment, the propulsion assembly may be associated with at least one propulsion state. Further, the at least one propulsion state may be associated with the movement of the body. Further, the rotatable head 202 may include at least one rotation damper configured to dampen stray rotation of the rotatable head 202. Further, the stray rotation may be associated with a stray movement of the body 220. Further, the stray movement may be disassociated with the at least one propulsion state.

Further, in an embodiment, the power source may include at least one of a DC power source and an AC power source. Further, the DC power source may include at least one detachable battery 208 and 222. Further, the at least one detachable battery 208 and 222 may be disposed within the body 220. Further, the at least one detachable battery 208 and 222 may be configured to supply electrical power to the at least one actuator and the propulsion assembly. Further, the at least one detachable battery 208 and 222 may include a lithium-ion battery. Further, in an instance, the at least one detachable battery 208 and 222 may last up to 8 hours. Further, the at least one detachable battery 208 and 222 may include a system voltage of 22.2 V (DC). Further, the at least one detachable battery 208 and 222 may include a battery recharge time of 3 hours.

Further, in an embodiment, the grabber device 206 and the at least one sensing device are fixedly mounted on the rotatable head 202 in a plurality of configurations. Further, the plurality of configurations allows overlapping of a field of grabber operation associated with the at least one grabber operation and a field of sensing operation associated with at least one sensing operation.

Further, in an embodiment, the grabber device 206 and the at least one sensing device are movably mounted on the rotatable head 202 in a plurality of configurations. Further, the plurality of configurations allows overlapping of a field of grabber operation associated with the at least one grabber operation and a field of sensing operation associated with at least one sensing operation. Further, the at least one actuator may be operationally coupled to the grabber device 206 and the at least one sensing device. Further, the at least one actuator operation may include arranging the grabber device 206 and the at least one sensing device in the plurality of configurations to control the overlapping of the field of grabber operation and the field of sensing operation.

Further, in an embodiment, the vehicular system 200 may include an input device communicatively coupled to the controller through at least one of a wired communication channel and a wireless communication channel. Further, the input device may be configured to transmit at least one command.

Further, in an embodiment, the vehicular system 200 may include at least one state sensor mounted on the body 220. Further, the at least one sensor may be configured to generate at least one state sensor data associated with the rotatable head 202. Further, the controller may be configured to control the at least one actuator based on the at least one sensor data.

Further, in an embodiment, the plurality of devices may include at least one tracking instrument. Further, the at least one tracking instrument may be configured to perform at least one tracking operation. Further, the at least one tracking operation may be associated with at least one object. Further, the at least one tracking instrument may be configured to generate at least one tracking instrument data associated with the at least one object. Further, the controller may be configured to control the at least one actuator based on the at least one tracking instrument data. Further, in an embodiment, the vehicular system 200 may include a communication device and a storage device. Further, the communication device may be communicatively coupled with the at least one tracking instrument. Further, the communication device may be configured to transmit the at least one tracking instrument data to at least one user device associated with at least one user. Further, in an embodiment, the vehicular system 200 may include a storage device communicatively coupled with the at least one tracking instrument. Further, the storage device may be configured to store the at least one tracking instrument data.

Further, in an embodiment, the vehicular system 200 may include the propulsion assembly. Further, the propulsion assembly may be electrically powered by a power source. Further, the propulsion assembly may include the plurality of thrusters 210, 212, 214, 216, 218, and 402. Further, the plurality of thrusters 210, 212, 214, 216, 218, and 402 may be configured to propel the vehicular system 200 in a plurality of directions in reference to the body 220. Further, the plurality of thrusters 210, 212, 214, 216, 218, and 402 may include an electric motor or a hydraulic motor built-in as a propulsion device. Further, the propulsion device may work under high pressure of water in the ocean. Further, in an instance, the plurality of thrusters 210, 212, 214, 216, 218, and 402 may include thruster control of 6 independent thrusters, infinitely variable and 100% reversible.

Further, in an embodiment, the vehicular system 200 may include the body 220. Further, the body 220 may be associated with three body axes. Further, the three-body axes are mutually perpendicular. Further, the three-body axes may include a vertical body axis, a lateral body axis, and a longitudinal body axis. Further, the rotatable head 202 may be configured to rotate about an axis through the plurality of positions. Further, the axis may be determined through a plurality of coordinates associated with each of the vertical body axis, the lateral body axis, and the longitudinal body axis. Further, the at least one actuator may be configured to rotate the rotatable head 202 about the axis. Further, the controller may be configured to control the at least one actuator based on the plurality of coordinates.

Further, in an embodiment, the vehicular system 200 may include the plurality of devices. Further, a device of the plurality of devices may include a camera 204. Further, the camera may include at least one camera lens. Further, the at least one camera lens may include a sapphire lens. Further, the camera 204 may be mounted on the rotatable head 202. Further, the camera 204 may face in the direction parallel to the ground for a good appealing photo/video frame. Further, in an instance, the camera 204 may include an 8-megapixel camera lens. Further, in an instance, the camera 204 may record video up to UHD 4K—3840×2160 30FPS and may include 0.001 Lux having 280° total range of view. Further, the camera 204 may be associated with the tracking of an object. Further, the object may include a fish, a whale, etc. Further, the object may be followed by the camera mounted on the rotatable head 202.

Further, in an embodiment, the vehicular system 200 may include the rotatable head 202. Further, the rotatable head 202 may include a rotatable head body. Further, the rotatable head body may include a closed shape with a hollow interior space. Further, the plurality of devices may be mounted on the rotatable head body. Further, the plurality of devices may include a plurality of lights. Further, the plurality of lights may include high efficiency LED, fully dimmable 7300 Lumens tracking with camera 204.

Further, in an embodiment, the vehicular system 200 may include the rotatable head 202. Further, the rotatable head 202 may include at least one orientation sensor. Further, the at least one orientation sensor may be configured to generate at least one orientation sensor data. Further, the at least one orientation sensor data may be associated with an orientation of the rotatable head 202 in relation to the body 220. Further, the orientation corresponds to a direction. Further, the propulsion assembly may be configured to propel the vehicular system 200 in the direction.

Further, in an embodiment, the vehicular system 200 may include the plurality of devices. Further, at least one device of the plurality of devices may be retractably mounted on the rotatable head 202. Further, the at least one device may be associated with two positions. Further, the two positions may include an extended position and a retracted position in relation to the rotatable head 202. Further, the at least one actuator may be operationally coupled with the at least one device. Further, the at least one actuator operation may include transitioning the at least one device between the two positions. Further, in an embodiment, the vehicular system 200 may include at least one input device communicatively coupled with the controller through at least one of a wired communication channel and a wireless communication channel. Further, the at least one input device may be configured to transmit a position command. Further, the position command may be associated with the two positions of the at least one device. Further, the controller may be configured to control the at least one actuator based on the position command.

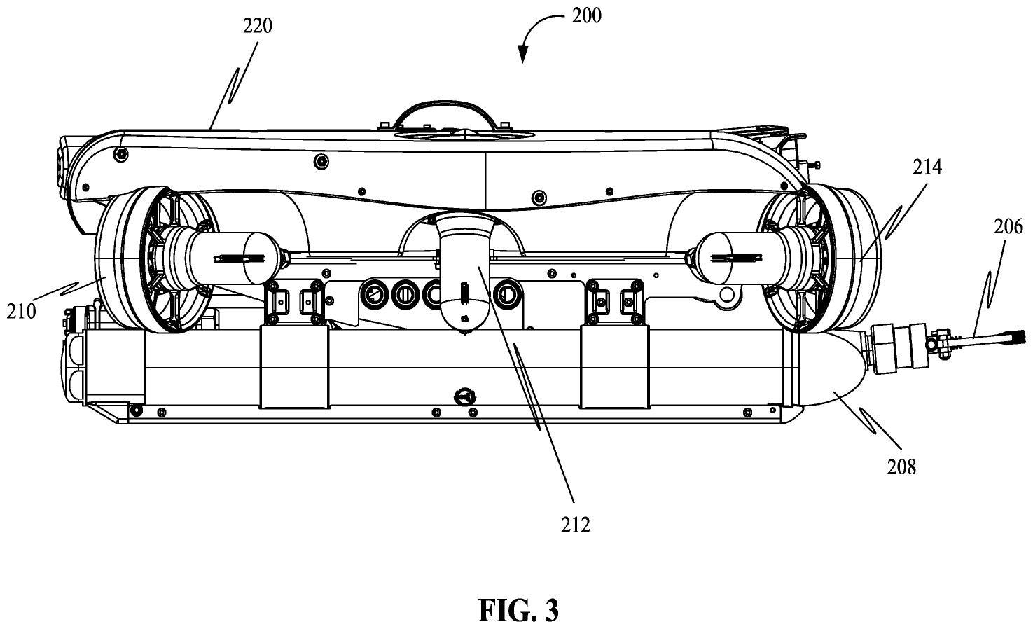

FIG. 3 is a side view of the vehicular system 200, in accordance with some embodiments.

FIG. 4 is a bottom view of the vehicular system 200, in accordance with some embodiments.

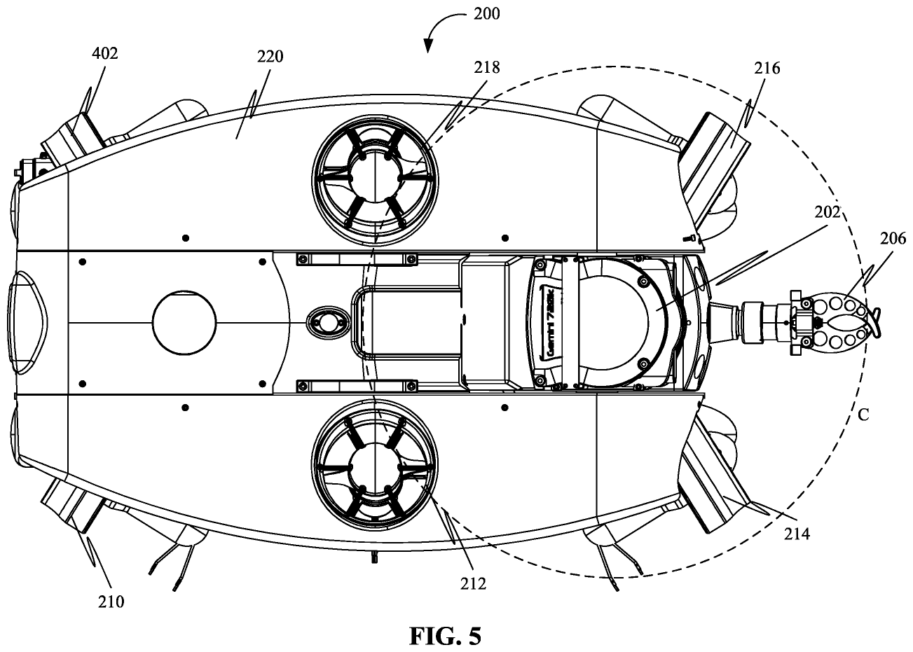

FIG. 5 is a top view of the vehicular system 200, in accordance with some embodiments.

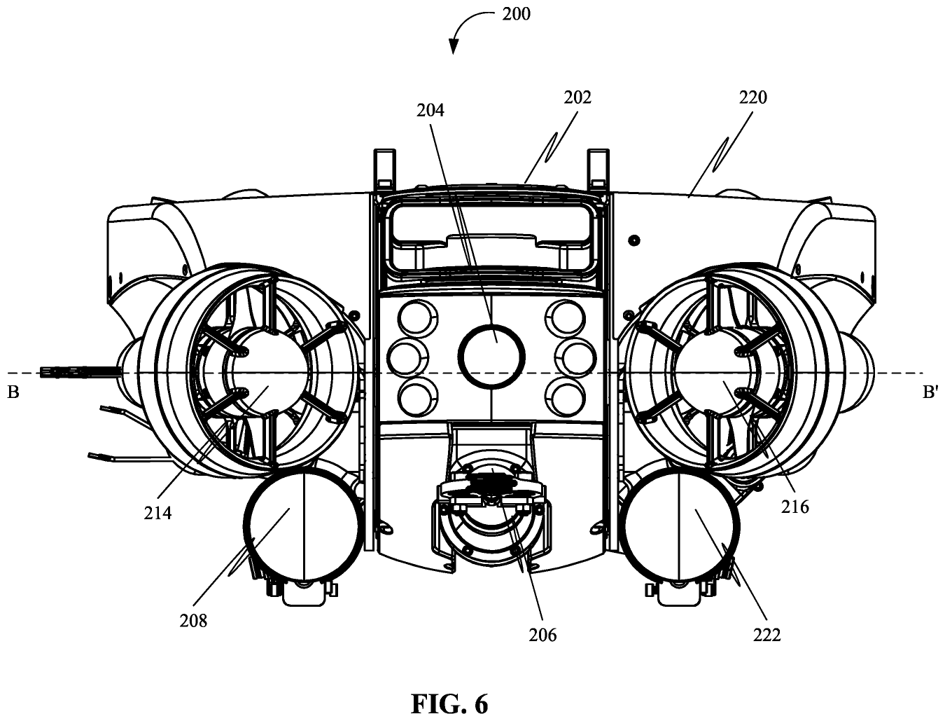

FIG. 6 is a front view of the vehicular system 200, in accordance with some embodiments.

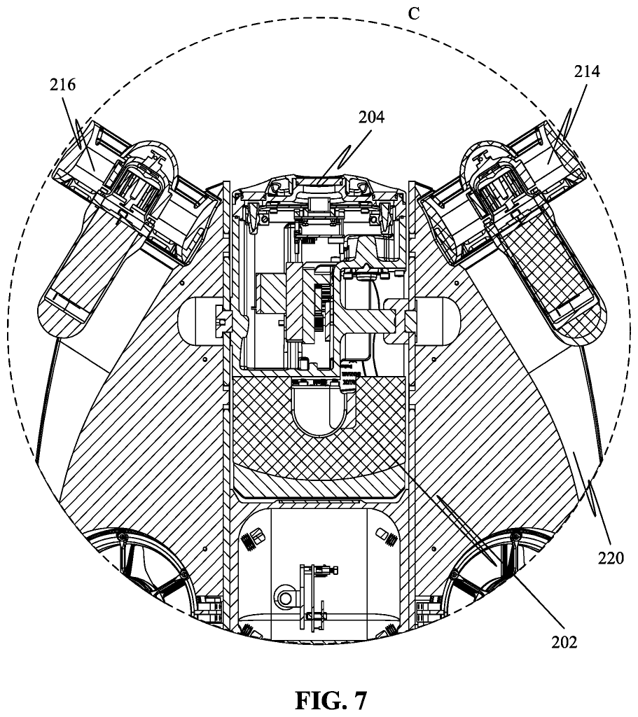

FIG. 7 is an enlarged cross-sectional view of region C in FIG. 5, in accordance with some embodiments. Further, the enlarged cross-sectional view of the region C is taken along the line B-B′ as shown in FIG. 6.

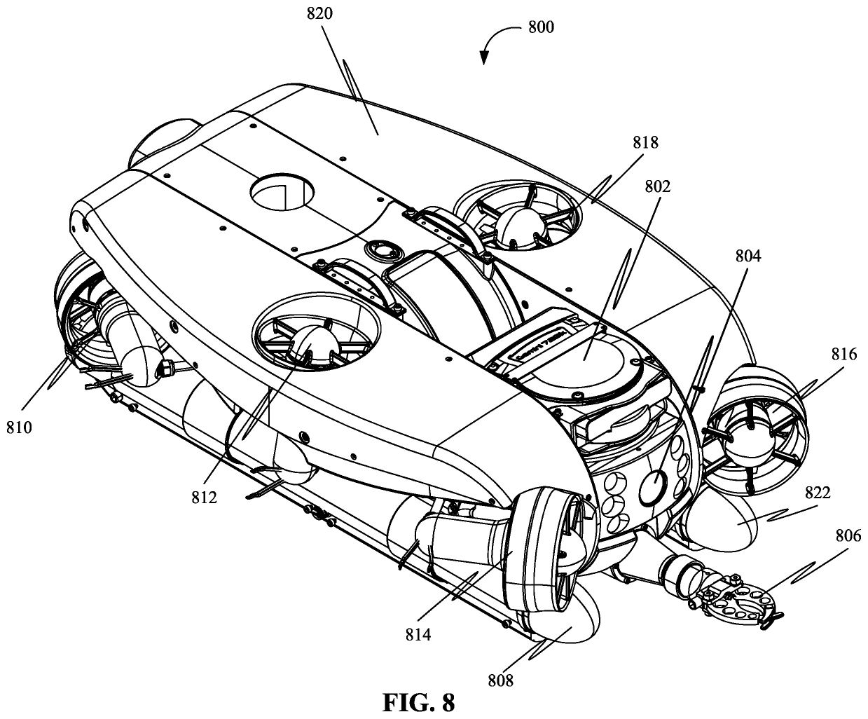

FIG. 8 is a perspective view of a vehicular system 800, in accordance with some embodiments. Further, the vehicular system 800 may include a body 820, a rotatable head 802, a plurality of devices, a propulsion assembly, at least one actuator, a power source, a controller.

Further, the body 820 may include the rotatable head 802, the plurality of devices, and the propulsion assembly. In some embodiments, the propulsion assembly may include a plurality of thrusters 810, 812, 814, 816 and 818. Further, the body 820, in an instance, may include a body material. Further, the body material may include anodized machined aluminum, carbon fiber, stainless steel, and buoyancy foam.

Further, the rotatable head 802 rotatably coupled to the body 820. Further, the rotatable head may be configured to rotate through a plurality of positions in relation to the body 820. Further, the plurality of devices mounted on the rotatable head 802. Further, the plurality of devices may include a grabber device 806 and at least one sensing device. Further, the grabber device 806 may be configured to perform at least one grabbing operation. Further, the grabber device 806 may include two grabber arms. Further, the two grabber arms may include a gripper material attached to the edge of the two grabber arms. Further, the gripper material may include a rubber, a neoprene, etc. Further, the at least one sensing device may be configured to perform at least one sensing operation. Further, the at least one sensing device may include a Sound Navigation and Ranging (SONAR) device, an Ultra-Short Baseline (USBL) device, a Doppler Velocity Log (DVL) device, and a laser scaler device. Further, the SONAR device may help in determining an obstruction beyond the visibility of the vehicular system 800. Further, the SONAR device may be configured to generate SONAR data. Further, SONAR data may be transmitted to the online platform 100. Further, the online platform 100 may be configured to receive the SONAR data. Further, the SONAR data may be transmitted to a user device. Further, the user device may be configured to receive the SONAR data. Further, the user device may include a controller. Further, in an instance, the controller may be a waterproof hand-held controller with 78 mm (7-inch) 16:9 wide-angle LCD screen. Further, in an instance, the controller may include connectivity options such as, but not limited to, USB, SD, HDMI, Ethernet, etc. Further, the USBL device may determine underwater acoustic positioning of the vehicular system 800. Further, the USBL device may be configured to generate USBL data. Further, the USBL data may be transmitted to the online platform 100. Further, the online platform 100 may be configured to receive the one USBL data. Further, the USBL data may be transmitted to the user device. Further, the user device may be configured to receive the USBL data. Further, the DVL device may determine velocity of the vehicular system 800 relative to the bottom of the ocean. Further, the DVL device may be configured to generate DVL data. Further, the DVL data may be transmitted to the online platform 100. Further, the online platform 100 may be configured to receive the DVL data. Further, the DVL data may be transmitted to the user device. Further, the user device may be configured to receive the DVL data. Further, the laser scaler device may determine size of an object in front of the vehicular system 800. Further, the object may include a fish, a whale, etc. Further, the laser scaler may be configured to generate laser scaler data. Further, the laser scaler data may be transmitted to the online platform 100. Further, the online platform 100 may be configured to receive the laser scaler data. Further, the laser scaler data may be transmitted to the user device. Further, the user device may be configured to receive the laser scaler data.

Further, the propulsion assembly coupled to the body 820. Further, the propulsion assembly may include the plurality of thrusters 810, 812, 814, 816 and 818. Further, the plurality of thrusters 810, 812, 814, 816 and 818 may be electrically powered. Further, the plurality of thrusters 810, 812, 814, 816 and 818 may be configured to propel the vehicular system 800 in a plurality of directions.

Further, the at least one actuator operationally coupled to the rotatable head 802. Further, the at least one actuator may be configured to perform at least one actuator operation. Further, the at least one actuator may include a hydraulic actuator, a pneumatic actuator, an electrical actuator, etc. Further, the at least one actuator operation may include rotating the rotatable head 802 through a plurality of positions in relation to the body 820.

Further, the power source electrically coupled to the at least one actuator and a propulsion assembly. Further, the power source may be configured to supply electrical power to the at least one actuator and the propulsion assembly.

Further, the controller communicatively coupled to the at least one actuator. Further, the controller may be configured to control the at least one actuator operation of the at least one actuator.

Further, in an embodiment, the vehicular system 800 may include the plurality of devices. Further, at least one device of the plurality of devices may be retractably mounted on the rotatable head 802. Further, the at least one device may be associated with two positions. Further, the two positions may include an extended position and a retracted position in relation to the rotatable head 802. Further, the at least one actuator may be operationally coupled with the at least one device. Further, the at least one actuator operation may include transitioning the at least one device between the two positions. Further, in an embodiment, the vehicular system 800 may include at least one input device communicatively coupled with the controller through at least one of a wired communication channel and a wireless communication channel. Further, the at least one input device may be configured to transmit a position command. Further, the position command may be associated with the two positions of the at least one device. Further, the controller may be configured to control the at least one actuator based on the position command.

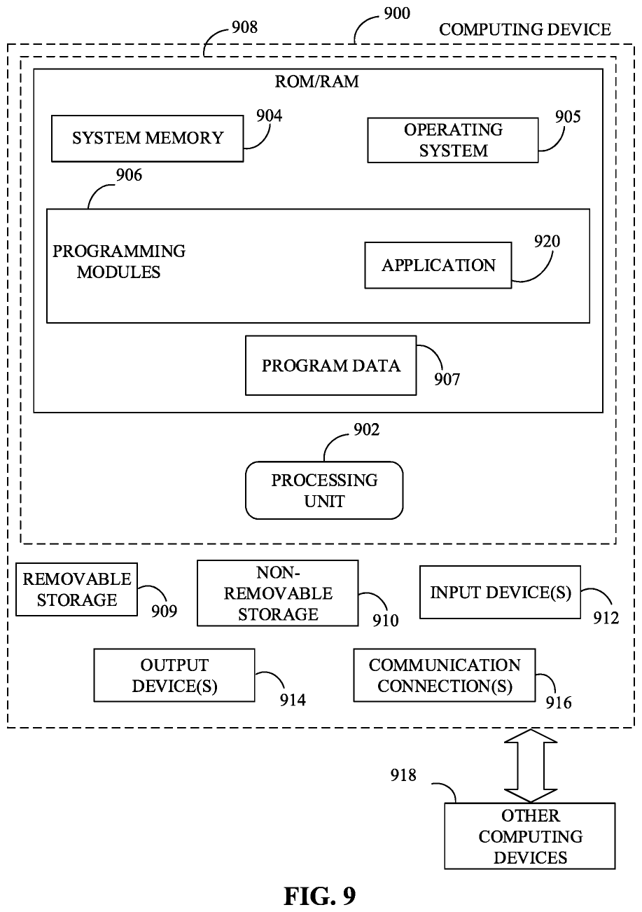

With reference to FIG. 9, a system consistent with an embodiment of the disclosure may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g. random-access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include an image-processing module, machine learning module. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and non-volatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, a location sensor, a camera, a biometric sensor, etc. Output device(s) 914 such as a display, speakers, a printer, etc. may also be included. The aforementioned devices are examples and others may be used.

Computing device 900 may also contain a communication connection 916 that may allow computing device 900 to communicate with other computing devices 918, such as over a network in a distributed computing environment, for example, an intranet or the Internet. Communication connection 916 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 904, including operating system 905. While executing on processing unit 902, programming modules 906 (e.g., application 920 such as a media player) may perform processes including, for example, one or more stages of methods, algorithms, systems, applications, servers, databases as described above. The aforementioned process is an example, and processing unit 902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit may include discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A vehicular system comprising:
a body;
a rotatable head rotatably coupled to the body, wherein the rotatable head is configured to rotate through a plurality of positions in relation to the body;
a plurality of devices mounted on the rotatable head, wherein the plurality of devices comprises a grabber device and at least one sensing device, wherein the grabber device is configured to perform at least one grabbing operation, wherein the at least one sensing device is configured to perform at least one sensing operation;
a propulsion assembly coupled to the body, wherein the propulsion assembly is electrically powered, wherein the propulsion assembly is configured to propel the vehicular system;
at least one actuator operationally coupled to the rotatable head, wherein the at least one actuator is configured to perform at least one actuator operation, wherein the at least one actuator operation comprises rotating the rotatable head through a plurality of positions in relation to the body;
a power source electrically coupled to the at least one actuator and a propulsion assembly, wherein the power source is configured to supply electrical power to the at least one actuator and the propulsion assembly; and
a controller communicatively coupled to the at least one actuator, wherein the controller is configured to control the at least one actuator operation of the at least one actuator.

2. The vehicular system of claim 1, wherein the propulsion assembly is associated with at least one propulsion state, wherein the at least one propulsion state is associated with movement of the body, wherein the rotatable head comprises at least one rotation damper configured to dampen stray rotation of the rotatable head, wherein the stray rotation is associated with stray movement of the body, wherein the stray movement is disassociated with the at least one propulsion state.

3. The vehicular system of claim 1, wherein the power source comprise at least one of a DC power source and an AC power source, wherein the DC power source comprises at least one detachable battery, wherein the at least one detachable battery is disposed within the body, wherein the at least one detachable battery is configured to supply electrical power to the at least one actuator and the propulsion assembly.

4. The vehicular system of claim 1, wherein the grabber device and the at least one sensing device are fixedly mounted on the rotatable head in a plurality of configurations, wherein the plurality of configurations allows overlapping of a field of grabber operation associated with the at least one grabber operation and a field of sensing operation associated with at least one sensing operation.

5. The vehicular system of claim 1, wherein the grabber device and the at least one sensing device are movably mounted on the rotatable head in a plurality of configurations, wherein the plurality of configurations allows overlapping of a field of grabber operation associated with the at least one grabber operation and a field of sensing operation associated with at least one sensing operation, wherein the at least one actuator is operationally coupled to the grabber device and the at least one sensing device, wherein the at least one actuator operation comprises arranging the grabber device and the at least one sensing device in the plurality of configurations to control the overlapping of the field of grabber operation and the field of sensing operation.

6. The vehicular system of claim 1 further comprising an input device communicatively coupled to the controller through at least one of a wired communication channel and a wireless communication channel, wherein the input device is configured to transmit at least one command, wherein the controller is configured to control the at least one actuator based on the at least one command.

7. The vehicular system of claim 1 further comprising at least one state sensor mounted on the body, wherein the at least one sensor is configured to generate at least one state sensor data associated with the rotatable head, wherein the controller is configured to control the at least one actuator based on the at least one sensor data.

8. The vehicular system of claim 1, wherein the plurality of devices comprises at least one tracking instrument, wherein the at least one tracking instrument is configured to perform at least one tracking operation, wherein the at least one tracking operation is associated with at least one object, wherein the at least one tracking instrument is configured to generate at least one tracking instrument data associated with the at least one object, wherein the controller is configured to control the at least one actuator based on the at least one tracking instrument data.

9. The vehicular system of claim 8 further comprises a communication device communicatively coupled with the at least one tracking instrument, wherein the communication device is configured to transmit the at least one tracking instrument data to at least one user device associated with at least one user.

10. The vehicular system of claim 8 further comprises a storage device communicatively coupled with the at least one tracking instrument, wherein the storage device is configured to store the at least one tracking instrument data.

11. The vehicular system of claim 1, wherein the propulsion assembly comprises a plurality of thrusters, wherein the plurality of thrusters is configured to propel the vehicular system in a plurality of directions in reference to the body.

12. The vehicular system of claim 1, wherein the body is associated with three body axes, wherein the three body axes are mutually perpendicular, wherein the three body axes comprises a vertical body axis, a lateral body axis, and a longitudinal body axis, wherein the rotatable head is configured to rotate about an axis through the plurality of positions, wherein the axis is determined through a plurality of coordinates associated with each of the vertical body axis, the lateral body axis, and the longitudinal body axis, wherein the at least one actuator is configured to rotate the rotatable head about the axis, wherein the controller is configured to control the at least one actuator based on the plurality of coordinates.

13. The vehicular system of claim 1, wherein a device of the plurality of devices comprises a camera, wherein the camera comprises at least one camera lens, wherein the at least one camera lens comprises a sapphire lens, wherein the camera is mounted on the rotatable head.

14. The vehicular system of claim 1, wherein the rotatable head comprises a rotatable head body, wherein the rotatable head body comprises a closed shape with a hollow interior space, wherein the plurality of devices is mounted on the rotatable head body.

15. The vehicular system of claim 1, wherein the rotatable head comprises at least one orientation sensor, wherein the at least one orientation sensor is configured to generate at least one orientation sensor data, wherein the at least one orientation sensor data is associated with an orientation of the rotatable head in relation to the body, wherein the orientation corresponds to a direction, wherein the propulsion assembly is configured to propel the vehicular system in the direction.

16. The vehicular system of claim 1, wherein at least one device of the plurality of devices is retractably mounted on the rotatable head, wherein the at least one device is associated with two positions, wherein the two positions comprises an extended position and a retracted position in relation to the rotatable head, wherein the at least one actuator is operationally coupled with the at least one device, wherein the at least one actuator operation comprises transitioning the at least one device between the two positions.

17. The vehicular system of claim 16 further comprises at least one input device communicatively coupled with the controller through at least one of a wired communication channel and a wireless communication channel, wherein the at least one input device is configured to transmit a position command, wherein the position command is associated with the two positions of the at least one device, wherein the controller is configured to control the at least one actuator based on the position command.

18. A vehicular system comprising:
a body;
a rotatable head rotatably coupled to the body, wherein the rotatable head is configured to rotate through a plurality of positions in relation to the body;
a plurality of devices movably mounted on the rotatable head, wherein the plurality of devices comprises a grabber device and at least one sensing device, wherein the grabber device is configured to perform at least one grabbing operation, wherein the at least one sensing device is configured to perform at least one sensing operation;
a propulsion assembly coupled to the body, wherein the propulsion assembly comprises a plurality of thrusters, wherein the plurality of thrusters is electrically powered, wherein the plurality of thrusters is configured to propel the vehicular system in a plurality of directions;
at least one actuator operationally coupled to the rotatable head, wherein the at least one actuator is configured to perform at least one actuator operation, wherein the at least one actuator operation comprises rotating the rotatable head through a plurality of positions in relation to the body;
a power source electrically coupled to the at least one actuator and a propulsion assembly, wherein the power source is configured to supply electrical power to the at least one actuator and the propulsion assembly; and
a controller communicatively coupled to the at least one actuator, wherein the controller is configured to control the at least one actuator operation of the at least one actuator.

19. The vehicular system of claim 18, wherein at least one device of the plurality of devices is retractably mounted on the rotatable head, wherein the at least one device is associated with two positions, wherein the two positions comprises an extended position and a retracted position in relation to the rotatable head, wherein the at least one actuator is operationally coupled with the at least one device, wherein the at least one actuator operation comprises transitioning the at least one device between the two positions.

20. The vehicular system of claim 19 further comprises at least one input device communicatively coupled with the controller through at least one of a wired communication channel and a wireless communication channel, wherein the at least one input device is configured to transmit a position command, wherein the position command is associated with the two positions of the at least one device, wherein the controller is configured to control the at least one actuator based on the position command.
